(19) United States
(12) Patent Application Publication
(10) Pub. No.: US 2008/0200615 A1
(43) Pub. Date: Aug. 21, 2008

(54) Thermoplastic Elastomer Composition

(76) Inventors: Godfried Johannes Franciscus Niemark, Amstenrade (NL); Marianna Sarkissova-Mikhaylova, Bunde (NL)

Correspondence Address: NIXON & VANDERHYE, PC, 901 NORTH GLEBE ROAD, 11TH FLOOR, ARLINGTON, VA, 22203, US

(21) Appl. No.: 10/586,127

(22) PCT Filed: Jan. 19, 2005
(86) PCT No.: PCT/NL05/00039

§ 371 Date: Nov. 7, 2006

(30) Foreign Application Priority Data
Jan. 19, 2004 (NL) PCT/NL04/00042

(51) Int. Cl. C08L 23/04; C08L 23/00; C08L 23/10; C08L 25/04

(52) U.S. Cl. 525/240; 525/191; 525/241

(57) ABSTRACT

A thermoplastic elastomer composition comprising 5-95 weight % of an oil free elastomer, 95-5 weight % of a polyolefin composition comprising from 20 to 50 parts by weight of a crystalline polyolefinic polymer and 50 to 80 parts by weight of an elastomeric olefinic copolymer whereby the total parts by weight is 100. The thermoplastic elastomer composition may comprise 0.02-10 weight % of a cross linking agent optionally with co-agent whereby the total weight of (a), (b) and the cross linking agent is chosen from a peroxide, hydrosilane or phenolic resins. The present invention further relates to articles comprising the thermoplastic elastomer composition and to the use of the thermoplastic elastomer composition in food packaging, industrial application, consumer applications, medical applications, seals, auto interior parts and low fogging applications as for example airbags and dashboards.

The present invention relates to a thermoplastic elastomer composition. The invention further relates to articles comprising the thermoplastic elastomer composition. The invention also relates to the use of the thermoplastic elastomer composition.

Thermoplastic elastomer compositions are known from “Handbook of Thermoplastic Elastomers, chapter 3, Van Nostrand Reinhold, New York (19**). The described thermoplastic elastomer composition corn prises a blend of a thermoplastic polyolefinic polymer, an elastomer and oil. Typically the elastomer is a high molecular weight rubber and is oil extended. This type of elastomer is used to obtain elastomeric compositions with good mechanical and elastic properties. Some extra oil is usually added during manufacturing of the thermoplastic elastomers to improve the flow properties of the final composition. Although the known thermoplastic elastomer compositions often possess desirable properties, the compositions seem not always preferred in for example medical, food or auto interior applications because of the migration of oil or other low molecular components present in the thermoplastic elastomer composition. Migration or bleeding of oil is a problem, which is known from EP-A-574169 and JP-A-03261728. In these applications rubber compositions are disclosed based on EPDM or EPM in which bleeding of oil is reduced by using either a minimum of oil or by using no oil at all. The applications are however silent about the reduction of migration of low molecular components.

Migration of low molecular components is disclosed in U.S. Pat. No. 6,100,333. A vulcanised polyolefin composition produced by sequential polymerisation is impregnated with an oil extender for regulating the hardness of the composition. It is disclosed that the tendency of blooming of low molecular components is considerably lower by impregnating the polyolefin composition with oil.

There is however a need to reduce the migration or blooming of low molecular components without the use of oil also within, for example packed food products and particularly food products comprising fat otherwise the food will be unusable for consumption.

The object of the present invention is to provide a thermoplastic elastomer composition with low migration of low molecular components, in particular low molecular components extractable in ethanol.

This object is achieved by a thermoplastic elastomer composition comprising

(a) 5-95 weight % of an oil free elastomer
(b) 95-5 weight % of a polyolefin composition comprising from 20 to 50 parts by weight of a crystalline polyolefin polymer and 50 to 80 parts by weight of an elastomeric olefin copolymer whereby the total parts by weight is 100.

Surprisingly, it has been found that a significant reduction of migration of low molecular components extractable in ethanol is achieved when the thermoplastic elastomer composition comprises the components (a) and (b). Moreover it is surprising that the replacement of oil by an oil free elastomer still allows the manufacturing of thermoplastic elastomers with a good balance of physical properties and processability. The oil free elastomers (a) according to the present invention are elastomers which have not been extended by appropriate amounts of oil also called non oil-extended elastomers. Examples of the non oil-extended elastomers are ethylene-propylene copolymers, hereinafter-called EPM, ethylene-propylene-diene terpolymers, hereinafter called EPDM, natural rubber, styrene-butadiene rubber (SBR), nitrile-butadiene rubber (NBR), polyisoprene, butyl rubber or halogenated butyl rubber. Preferably EPM or EPDM is used as non oil-extended elastomer. The EPDM preferably contains 50-90 parts by weight ethylene monomer units, 48-30 parts by weight monomer units originating from an alpha-olefin and 1-12 parts by weight monomer units originating from a non-conjugated diene. As alpha-olefin use is preferably made of propylene. As non-conjugated diene use is preferably made of dicyclopentadiene (DCPD), 5-ethylidene-2-norbornene (ENB) or vinylnorbornene (VNB) or mixtures thereof. More preferably a mixture of EPM and EPDM is used as oil free elastomer. In case that a mixture of EPM and EPDM is used, the weight ratio EPM/EPDM may vary between 10/90 and 90/10. The amount of oil free elastomer varies between 5-95 weight %, preferably between 25-75 weight % of the thermoplastic elastomer composition. The oil free elastomer may however also be replaced by other polymers as long as they do not comprise oil, for example styrene based polymers like SBS, SEBS or SEPS.

The polyolefin composition (b) comprises from 20 to 50 parts by weight of a crystalline polyolefin and 50 to 80 parts by weight of an elastomeric olefin copolymer whereby the total parts by weight is 100. More preferably, the polyolefin compositions comprise between 20 and 40 parts by weight of a crystalline polyolefin and between 60 and 80 parts by weight of an elastomeric olefin copolymer whereby the total parts by weight is 100. Most preferably between 30 and 40 parts of a crystalline polyolefin and between 60 and 70 parts of an elastomeric olefin copolymer whereby the total parts by weight is 100.

Preferably the polyolefin composition comprises 20 to 50 parts by weight of a crystalline polyolefin and from 50 to 80 parts by weight of an elastomeric olefin copolymer with olefins CH₂═CHR, in which R is alkyl having 1 to 10 carbon atoms, and, if appropriate, containing minor proportions of units derived from a polyene.

The crystalline polyolefin is preferably selected from polypropylene homopolymer and propylene copolymers containing 0.5 to 15 mol % of ethylene and/or an. alpha-olefin having 4 to 10 carbon atoms, the said propylene polymer for example has a molecular weight distribution (MWD) greater than 3.5.

The propylene homo polymer preferably has an isotactic index, determined by measurement of the solubility in xylene, greater than 85 and more preferably greater than 90. It is preferable for the propylene polymer to have an MWD greater than 5 and generally between 5 and 50. The melt index (ASTM 1238 condition “L”) of the propylene polymer is generally between 0.1 and 50 g/10 minutes. Preferably the melt index is between 0.1 and 30. The propylene copolymer for example comprises from 2 to 10 mol % of an alpha-olefin other than propylene. Preferably, the alpha-olefin is selected from the group comprising ethylene, 1-butene, 1-hexene, 1-octene and 4-methyl-1-pentene. Among these, ethylene and 1-butene are particularly preferred.

The propylene polymers of the present invention can be prepared according to known technologies by polymerisation of propylene, if appropriate in the presence of ethylene or other alpha.-olefins, in the presence of conventional catalysts of the Ziegler/Natta type comprising the product of the reaction between an aluminium alkyl and a solid component comprising a transition metal supported on MgCl₂ in an active form. Suitable methods for preparing the propylene polymers are described, for example, in EP-A-395083, EP-A-553805 and EP-A-553806, the description of which, relating to the method of preparation and to the characteristics of the products, is incorporated herein by reference.

The elastomeric olefin copolymer is preferably selected from the copolymers of ethylene with alpha.-olefins CH₂═CHR in which R is alkyl having 1 to 6 carbon atoms. More preferably, the alpha.-olefin is propylene or butene. In said copolymer, the content by weight of units derived from ethylene is preferably between 40 and 70%, more preferably between 50 and 70% most preferable between 60 and 70%. The content by weight of units derived from alpha.-olefins is preferably between 30 and 60%, more preferably between 30 and 50%, most preferably between 30 and 40%.

Particularly preferred are the copolymers, which contain 0.1 to 20% by weight, preferably 1 to 10%, of units derived from a polyene. Such a polyene can be selected from the group comprising trans-1,4-hexadiene, cis-1,4-hexadiene, 6-methyl-1,5-heptadiene, 3,7-dimethyl-1,6-octadiene and 11-methyl-1,10-dodecadiene; monocyclic diolefins such as, for example, cis-1,5-cyclooctadiene and 5-methyl-1,5-cyclooctadiene; bicyclic diolefins such as, for example, 4,5,8,9-tetrahydroindene and 6- and/or 7-methyl-4,5,8,9-tetrahydroindene; alkenyl- or alkylidene-norbornenes such as, for example, 5-ethylidene-2-norbornene, 5-isopropylidene-2-norbornene and exo-5-isopropenyl-2-norbornene; polycyclic diolefins such as, for example, dicyclopentadiene, tricyclo-[6.2.1.0²,7]4,9-undecadiene and the 4-methyl derivative thereof, 1,4-hexadiene, isoprene, 1,3-butadiene, 1,5-hexadiene, 1,6-heptadiene and so on. Among these, 5-ethylidene-2-norbornene is particularly preferred. The elastomeric ethylene copolymer preferably has a low crystallinity. Preferably, the elastomeric ethylene copolymer used in the present invention has an MWD of lower than 3, generally of between 2 and 3.

The elastomer olefin copolymer can advantageously be prepared by polymerising mixtures of ethylene, alpha-olefin and, if appropriate, polyene in the presence of a catalytic system comprising a metallocene compound and an alumoxane.

The polyolefin compositions (b) can be prepared by using known methodologies such as mechanical mixing of the two components by means of internal mixers of the Banbury type, having a high homogenizing power. Alternatively, the said compositions can advantageously be obtained directly in the reactor by means of sequential polymerisation. The compositions obtained according to this technique in fact show better elastomeric properties than those of the compositions obtained by simple mechanical mixing. The above-mentioned polyolefin compositions (b) are preferably prepared by the process described in WO-A-9635751. These polyolefin compositions, also known as reactor TPO's, are commercially available for example under the tradename Hifax®.

The polyolefin compositions (b) may however be replaced by other polymers for example by amorphous polypropylene or ethylene copolymers known in the prior art as Plastomers.

The thermoplastic elastomer composition comprising (a) and (b) preferably comprises 0.02-10 weight % of a cross linking agent optionally with co-agent whereby the total weight of the thermoplastic elastomer composition is 100.

The cross linking agents, which can be used are those commonly known in the art, such as sulfur, sulfurous compounds, metal oxides, maleimides, phenol resins or peroxides. These vulcanisation systems are known from the state of the art and are described in U.S. Pat. No. 5,100,947. It is also possible to use silane compounds as vulcanisation agent, examples are hydrosilane or vinylalkoxysilane. Possible is to subject the elastomer to free radical grafting with a silane which has at least one olefinic double bond and one to three alkoxy groups bonded directly to the silicon. The grafted elastomer is crosslinked under influence of H₂O or condensation reaction. This vulcanisation system is known form the state of the art and described in EP-A-510559. Preferably organic peroxides, phenolic resins or hydrosilanes are used as cross linking agent.

Examples organic peroxides are dicumyl peroxide, di-tert-butylperoxide, 2,5-dimethyl-(2,5-di-tert-butylperoxy)hexane, 1,3-bis(tert-butylperoxyisopropyl)benzene, 1,1-bis(tert-butylperoxy)-2,3,5-trimethylcyclohexane, benzoyl peroxide, 2,4-dichlorobenzoyl peroxide, tert-butyl peroxybenzoate, tert-butyl peroxyisopropylcarbonate, diacetyl peroxide, lauroyl peroxide, tert-butyl cumyl peroxide.

The amount of cross linking agent is preferably between 0.02-10% by weight and more preferably between 0.4-5% by weight relative to the total weight of the thermoplastic elastomer composition.

A co-agent may optionally be used during the vulcanisation. Examples of suitable co-agents are polybutylene, liquid 1,2-polybutadiene, isoprene, butadiene/isoprene mixtures, divinyl benzene, sulphur, p-quinondioxime, nitrobenzene, diphenylguanidine, triarylcyanurate, trimethylolpropane-N,N-m-phenylenedimaleimide, ethyleneglycol dimethacrylate, polyethylene dimethacrylate, trimethylolpropane trimethacrylate, arylmethacrylate, vinylbutylate and vinylstearate. The amount of co-agent is preferably between 0-2.00% by weight relative to the total weight of the thermoplastic elastomer composition.

In case of vulcanisation, dynamically vulcanisation is preferred. When working according to this technique, the composition of the invention is subjected to kneading or to other shear forces in the presence of cross linking agents and, if appropriate, co-agents at temperatures between for example 140° and 300° C., preferably at temperatures between 240° and 300° C. or more preferably at temperatures higher than the melting point of the crystalline phase.

The degree of vulcanisation of the elastomer composition can be expressed in terms of gel content. Gel content is the ratio of the amount of non-soluble elastomer and the total amount of elastomer (in weight) of a specimen soaked in an organic solvent for the elastomer. The method is described in U.S. Pat. No. 5,100,947. In general terms a specimen is soaked for 48 hours in an organic solvent for the elastomer at room temperature. After weighing of both the specimen and the residue the amount of non-soluble elastomer and total elastomer are calculated, based on knowledge of the relative amounts of all components in the thermoplastic elastomer composition. The elastomer composition is at least partially vulcanised.

The thermoplastic elastomer composition according to the present invention may also comprise for example reinforcing and non-reinforcing fillers, plasticizers, antioxidants, stabilizers, antistatic agents, waxes, foaming agents, lubricants, pigments, flame retardants and other known agents described in for example the Rubber World Magazine Blue Book. Examples of fillers that may be used are calcium carbonate, clay, silica, talc, titanium dioxide, and carbon. Examples of lubricants are natural products like fatty acids, wool grease, glue, rosin or modified natural products like factice.

The thermoplastic elastomer composition (a), (b) of the present invention may additionally comprise a styrene-based polymer. Examples of styrene-based polymers are styrene-isobutylene-styrene (SIBS), styrene-isobutylene (SIB), styrene-ethylene-butylene-styrene polymers (SEBS) or styrene-butadiene-styrene polymers abbreviated as (SBS). Preferably SBS or SEBS is used as styrene based polymer. The amount of the styrene-based polymer may for example vary between 2-50 weight %, preferably between 5-40 weight %, more preferably between 5-20 weight % whereby the total weight of the thermoplastic elastomer composition is 100.

The thermoplastic elastomer composition is for example prepared in conventional mixing equipment for example a Banbury mixer, a Brabender mixer, a continuous mixer for example a single screw extruder, a twin screw extruder and the like. Preferably the thermoplastic elastomer composition is prepared in a twin-screw extruder. In case of vulcanising, the cross linking gent and optionally co-agent, may be fed in whole or in part at a place downstream in the extruder. In case that a styrene-based polymer is present in the thermoplastic elastomer composition the cross linking agent may be fed before or after the styrene-based polymer. Preferably it is fed before injecting the styrene-based polymer. The styrene-based polymer may also be fed at the entry port of the extruder together with the oil free elastomer (a) and the polyolefin composition (b). The thermoplastic elastomer composition may also be prepared in a two-steps process by feeding the oil free elastomer (a), the polyolefin composition (b) and usual additives to a batch kneader in order to mix the composition were after granules may be produced. In case of vulcanising, the granules may for example be fed to a twin-screw extruder. The cross linking agent and optionally the styrene-based polymer may be fed in whole or in part at a place downstream in the extruder. The styrene polymer may however also be fed to the batch kneader or be fed to the entry port of the twin-screw extruder.

The thermoplastic elastomer composition according to the present invention surprisingly has a low hardness which the polymers processable using different techniques. The hardness is for example below 70 Shore A, preferably below 65 Shore A.

The thermoplastic elastomer composition according to the present invention can be used for the manufacturing of articles in all processes including for example by extrusion, moulding for example injection moulding or blow moulding or thermoforming. Examples of articles are writing utensils, seals for various containers, preservation jars, sealing gaskets for food savers, caps and closure seals and seals for various containers.

The thermoplastic elastomer composition according to the present invention may be used in food packaging, industrial applications, consumer applications, food consumer applications, medical applications and seals auto interior parts and low fogging applications as for example airbags and dashboards.

The following examples are given for illustrative purposes and do not limit the invention itself.

The different properties of the thermoplastic elastomer composition were analysed by using the following test methods:
Hardness according to ASTM D-2240
Apparent Shear Viscosity at 206 μs, at 220 C according to ASTM D-3835 Compression set according to ISO 815
Migration of extractables according to EC 2002-72
   Regarding the migration test, the amount of extractables in ethanol are determined according to the procedure described below

95% Ethanol was used as extraction liquid and prepared by addition of 950 ml ethanol (Lichrosolv, >99.9%) to 50 ml demi-water and subsequent mixing.

Before use all glassware was washed extensively with extraction liquid.

Samples were cut in pieces.

Before extraction samples were cleaned with tissue and ethanol to remove dust and other contaminants.

100 ml Schott flasks were extensively washed with extraction liquid and dried.

Approx. 1 dm2 (1 dm2=12.68 g) of the sample was put in Schott flasks.

Approx. 100 ml extraction liquid per dm2 was added to the flask.

The samples were extracted for 240 h hours at 40° C.

The extraction liquid was evaporated to dryness in an aluminium dish at 50° C. The flasks were flushed with 3*20 ml extraction liquid, which was also evaporated. Before use aluminium dishes were extensively washed with extraction liquid, dried and weighed.

The residues were determined by weighting.

Experiment was conducted in 7-fold.

A blank (everything without sample) was also conducted. Results were corrected for the blank value.

### EXAMPLE 1

21.53 weight % of EPM (ML (1+4) 100° C. 51) is mixed with 75.35 weight % Hifax 7334 XEP® and 0.43 weight % of additives on a 40 mm co-rotating twin screw extruder at a melt temperature of 260° C. Downstream in the extruder 2.69 weight % of Trigonox 101E30® is injected. The properties and results of this composition are shown in table 1.

### EXAMPLE 2

14.40 weight % of EPM (ML (1+4) 100° C. 51), 14.40 weight % of EPDM (ML (1+4) 100° C. 55), 67.21 weight % of Hifax 7334 XEP® and 0.38 weight % of additives are mixed on a 40 mm co-rotating twinscrew extruder at a melt temperature of 260° C. Downstream in the extruder 3.60 weight % of Trigonox 101 E30® is injected. The properties and results of this composition are shown in table

### EXAMPLE 3

17.91 weight % of EPM (ML (1+4) 100° C. 51), 8.96 weight % of EPDM (ML (1+4) 100° C. 55), 62.70 weight % of Hifax 7334 XEP®, 0.35 weight % of additives and 6.72 weight % of SEBS are mixed on a 40 mm co-rotating twin screw extruder at a melt temperature of 260° C. Downstream in the extruder 3.36 weight % of Trigonox 101E30® is injected. The properties and results of this composition are shown in table1.

### EXAMPLE 4

14.40 weight % of EPM (ML (1+4) 100° C. 51), 14.40 weight % of EPDM (ML (1+4) 100° C. 55), 70.81 weight % of Hifax 7334 XEP® and 0.38 weight % of additives are mixed on a 40 mm co-rotating twin-screw extruder at a melt temperature of 260° C. The properties and results of this composition are shown in table 1.

### EXAMPLE 5

14.40 weight % of EPM (ML (1+4) 100° C. 51), 14.40 weight % of EPDM (ML (1+4) 100° C. 55), 62.21 weight % of Hifax 7334 XEP® and 0.35 weight % of additives are mixed on a 40 mm co-rotating twin screw extruder at a melt temperature of 260° C. Downstream in the extruder 3.36 weight % of Trigonox 101E30® and 5 weight % of Ricon 154D® is injected. The properties and results of this composition are shown in table 1.

### Comparative Experiment A

62.32 weight % of oil extended EPDM comprising 100 phr of oil, 14.08 weight % of polypropylene and 5.87 weight % talc are mixed on a 40 mm co-rotating screw extruder. Downstream 0.94 weight %. Trigonox 101E 30® and 0.32 weight % co-agent are injected. The properties and results are shown in table 2.

TABLE 1

| | Example 1 | Example 2 | Example 3 | Example 4 | Example 5 |
|---|---|---|---|---|---|
| | weight % | weight % | weight % | weight % | weight % |
| EPM | 21.53 | 14.40 | 17.91 | 14.40 | 14.40 |
| (ML (1 + 4) 100° C. 51) | | | | | |
| EPDM | | 14.40 | 8.96 | 14.40 | 14.40 |
| (ML (1 + 4) 100° C. 55) | | | | | |
| Hifax 7334 XEP ® | 75.35 | 67.21 | 62.70 | 70.81 | 62.21 |
| SEBS | | | 6.72 | | |
| Trigonox 101E30 ® | 2.69 | 3.60 | 3.36 | | 3.36 |
| Ricon 154D ® | | | | | 5.00 |
| Additives | 0.43 | 0.38 | 0.35 | 0.38 | 0.35 |
| Hardness Shore A | 65 | 60 | 66 | 68 | 61 |
| CS at 23° C. for 72 h (%) | 69 | 83 | 64 | 94 | 38 |
| Viscosity 220° C. (Pa · s) | 843 | 541 | 480 | 365 | 320 |
| Migration (mg/dm2) | 23 | 18 | 26 | 15 | 11 |

TABLE 2

| Comparative exp. A | Weight % |
|---|---|
| EPDM, oil extended | 60.32 |
| Polypropylene | 14.18 |
| Talc | 5.87 |
| Trigonox 101^{E}30 | 0.94 |
| Co-agent | 0.32 |
| Additive | 0.39 |
| Oil | 18.09 |
| Hardness shore A | 62 |
| CS at 23° C. for 72 h | 24 |
| (%) | |
| Viscosity 220° C. (Pa · s) | 180 |
| Migration (mg/dm2) | 292 |

From table 1, example 1 it is clear that the migration of extractables in ethanol is reduced significantly.

From example 2 it is clear that a vulcanised thermoplastic elastomer composition comprising 2 different oil free elastomers and a polyolefine composition results in an even lower migration of extractables in ethanol. As shown in example 3 the addition of SEBS highers the migration of extractables negligible. From example 4 it is clear that also non crosslinked thermoplastic elastomer compositions show a low migration of extractables in ethanol. As can be derived from example 5 the migration of extractables in ethanol is at a very low level in case that the thermoplastic elastomer composition is crosslinked in the presence of a co-agent.

From table 2, it is clear that a vulcanized thermoplastic elastomer comprising the above components results in higher migration of extractables.

1. A thermoplastic elastomer composition comprising:
(a) 5-95 weight % of an oil free elastomer
(b) 95-5 weight % of a polyolefin composition comprising from 20 to 50 parts by weight of a crystalline polyolefinic polymer and 50 to 80 parts by weight of an elastomeric olefinic copolymer whereby the total parts by weight is 100.

2. A thermoplastic elastomer composition according to claim 1 comprising 0.02-10 weight % of a cross linking agent optionally with co-agent whereby the total weight of (a), (b) and the cross linking agent is 100.

3. A thermoplastic elastomer composition according to claim 2 characterised in that the cross linking agent is chosen from a peroxide, hydrosilane or phenolic resins.

4. A thermoplastic elastomer composition according to claim 1 characterised in that it the oil free elastomer (a) is chosen from EPM, EPDM or a mixture of EPM and EPDM.

5. A thermoplastic elastomer composition according to claim 1 characterised in that the polyolefin composition (b) comprises a polypropylene homopolymer or propylene copolymer as crystalline polyolefinic polymer and a ethylene copolymer with olefins having the formula CH₂═CHR in which R is an alkyl having 1-10 carbon atoms as elastomeric olefinic copolymer.

6. A thermoplastic elastomer composition according to claim 1 characterised in that the composition comprises a styrene based polymer whereby the total weight of the thermoplastic elastomer composition is 100.

7. A thermoplastic elastomer composition according to claim 1 characterised in that the composition comprises 2-50 weight % of a styrene based polymer whereby the total weight of the thermoplastic elastomer composition is 100.

8. A thermoplastic elastomer composition according to claim 6 characterised in that the styrene-based polymer is chosen from SBS, SEBS or SEPS.

9. A thermoplastic elastomer composition according to claim 1 characterised in that the co-agent is 1,2-polybutadiene.

10. Articles comprising the thermoplastic elastomer composition according to claim 1.

11. Use of the thermoplastic elastomer composition according to claim 1 in food packaging, industrial applications, consumer applications, medical applications, seals, auto interior parts and low fogging applications as for example airbags and dashboards.
